(19) United States
(12) Patent Application Publication
(10) Pub. No.: US 2026/0336018 A1
(43) Pub. Date: Oct. 29, 2026

(54) METHOD FOR INTRODUCING SEPARATING CUTS INTO PANEL-SHAPED WORKPIECES

(71) Applicant: TRUMPF Werkzeugmaschinen SE + Co. KG, Ditzingen (DE)

(72) Inventors: Patrick Mach, Korb (DE); Michael Krutzke, Sindelfingen (DE); Markus Blaschka, Schönaich (DE)

(21) Appl. No.: 19/703,109

(22) Filed: Jun. 10, 2026

Related U.S. Application Data
(63) Continuation of application No. PCT/EP2024/083826, filed on Nov. 27, 2024.

(30) Foreign Application Priority Data
Dec. 12, 2023 (DE) 10 2023 134 846.9

(51) Int. Cl. B23K 26/03; B23K 26/08; B23K 26/38

(52) U.S. Cl. CPC B23K 26/032; B23K 26/0869; B23K 26/38

(57) ABSTRACT

A method for introducing separating cuts into a panel-shaped workpiece using a laser processing head of a laser cutting machine, the method including monitoring a distance of the laser processing head to the workpiece and detecting scattered light arising during a cutting process, at least when a separating cut approaches an edge of the workpiece. The method further includes, based on detecting an abrupt change in the distance between the laser head and the workpiece as well as a simultaneous abrupt change in an intensity of the detected scattered light, determining that the edge of the workpiece has been reached and switching off a laser of the laser processing machine.

### CROSS REFERENCE TO RELATED APPLICATIONS

This application is a continuation of International Application No. PCT/EP2024/083826 (WO 2025/124907A1), filed on Nov. 27, 2024, and claims benefit to German Patent Application No. DE 10 2023 134 846.9, filed on Dec. 12, 2023. The aforementioned applications are hereby incorporated by reference herein.

### FIELD

The invention relates to a method for introducing separating cuts into panel-shaped workpieces using a laser processing head of a laser cutting machine.

### BACKGROUND

During the laser cutting of large sheet metal panels, the separating of the cut-out parts and the disposing of the residual scrap skeleton as waste is difficult. To facilitate these tasks, cutting operations are programmed that cut up the sheet metal panel across its entire width and/or length. It is often the case that the sheet metal panels to be cut are larger than the ordered panel sizes, since the dimensions of the panels can only be produced within a certain tolerance range in the rolling mill. In contrast, when programming separating cuts in the laser cutting machine, the ordered sheet dimension is usually used, which often results in separating cuts being too short, and thus the scrap skeleton at the end of the panel separating cut remaining connected over several millimeters. This connection point on the scrap skeleton must then be manually separated in a separate work step.

If, on the other hand, the separating cut is programmed to be longer than the nominal panel dimension, the workpiece support of the machine may be damaged by the laser beam if the laser beam is not switched off after the workpiece edge has been reached. Furthermore, any regulating of the distance between the laser processing head and the workpiece to a target value must be deactivated before the workpiece edge has been reached in order to prevent the laser processing head from lowering onto the workpiece support if the separating cut is longer than the panel dimension.

### SUMMARY

In an embodiment, the present disclosure provides a method for introducing separating cuts into a panel-shaped workpiece using a laser processing head of a laser cutting machine, the method comprising monitoring a distance of the laser processing head to the workpiece and detecting scattered light arising during a cutting process, at least when a separating cut approaches an edge of the workpiece. The method further comprises, based on detecting an abrupt change in the distance between the laser head and the workpiece as well as a simultaneous abrupt change in an intensity of the detected scattered light, determining that the edge of the workpiece has been reached and switching off a laser of the laser processing machine.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a diagram with a distance measurement signal and a scattered light measurement signal in an end portion of a separating cut.

### DETAILED DESCRIPTION

In an embodiment, the present disclosure provides a method for introducing separating cuts into panel-shaped workpieces, with which a complete severing of the workpiece and a reliable switch-off of the laser is made possible when the workpiece edge has been reached.

The foregoing is achieved according to the present disclosure by a method for introducing separating cuts into panel-shaped workpieces using a laser processing head of a laser cutting machine, characterized in that, at least when the separating cut approaches an edge of the workpiece, the distance of the laser processing head to the workpiece is monitored and the scattered light arising during the cutting process is detected, and in the event of an abrupt change in the distance between the laser head and the workpiece as well as a simultaneous abrupt change in the intensity of the detected scattered light, it is recognized that the edge of the workpiece has been reached and the laser of the laser processing machine is switched off.

To recognize the workpiece edge, the distance between the laser processing head of the machine and the workpiece is monitored. At the end of a sheet metal panel, the distance signal undergoes an abrupt change.

When solely evaluating the distance signal in order to switch off the laser, false triggering of the laser switch-off can occur, in particular in the case of thinner sheets, due to vibration of the sheet or rounded sheet edges.

In an embodiment of a method according to the present disclosure, the distance signal for workpiece edge recognition is therefore validated by a second measurement signal, in this case an optical measurement signal caused by scattered light. This signal falls sharply when the workpiece edge has been reached. The evaluation of the scattered light signal alone could also lead to incorrect switch-offs of the laser if the laser passes over a support bar of the workpiece support after reaching the workpiece edge. In this case, the scattered light signal would only fall after crossing the bar and trigger a switch-off of the laser, and not upon reaching the workpiece edge.

According to the present disclosure, both measurement signals are therefore evaluated. If the distance monitoring signal indicates that a workpiece edge has been reached by an abrupt rise in the value, the scattered light signal is evaluated simultaneously. The laser is only be switched off if both signals undergo an abrupt change. This largely prevents false triggering of the laser switch-off caused by a vibrating sheet, rounded workpiece edges or other interfering influences. The evaluation of both measurement signals ensures the required process reliability of the method according to the present disclosure.

The advancement speed of the laser processing head can preferably be reduced when the separating cut approaches an edge of the workpiece in order to facilitate the evaluation of the measurement signals and the triggering of the laser switch-off. Furthermore, reducing the advancement speed generates more scattered light, i.e., the optical signal is amplified before it falls abruptly when the workpiece edge has been reached by the separating cut.

The laser power can also be reduced when the separating cut approaches an edge of the workpiece. If the laser is switched off with a slight delay, damage to the base of the laser cutting machine is significantly reduced due to the lower laser power, or can even be avoided entirely.

Preferably, the laser power and advancement speed can be reduced simultaneously and linearly as a workpiece edge is approached.

There are various ways to measure the distance between the laser processing head and the workpiece. Preferably, the distance between the laser processing head and the workpiece can be measured capacitively. In this case, a surface on the processing head and an opposite surface of the workpiece form a capacitor which has capacitance that changes with the mutual distance between these surfaces.

The scattered light can preferably be detected by means of a photodiode.

To ensure that the workpiece is completely severed, the length of the separating cut is expediently programmed prior to processing of the workpiece to be greater than the nominal dimension of the workpiece in the direction of the separating cut.

The present disclosure also relates to a laser cutting machine having a laser processing head for processing panel-shaped workpieces, characterized in that it is equipped with a sensor device for measuring the distance of the laser processing head to the workpiece and has an optical sensor device for detecting scattered light and is configured to carry out a method according to the present disclosure.

The sensor device for measuring the distance between the processing head and a workpiece can be a capacitive sensor device.

The optical sensor device can have at least one photodiode.

Both sensor devices are connected to a control device of the laser cutting machine, so that their signals can be evaluated there and trigger a switch-off of the laser.

Further features and advantages of the present disclosure can be found in the description and the drawing. According to the present disclosure, the features mentioned above and those yet to be explained further can be used in each case individually or together in any desired expedient combinations. The embodiments shown and described should not be understood as an exhaustive list, but rather are of an exemplary character.

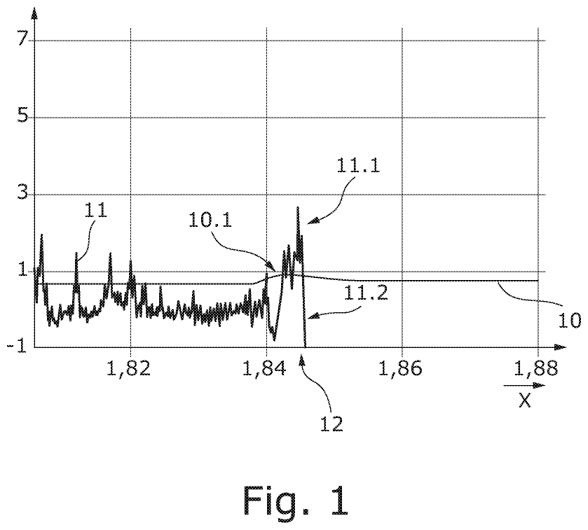

FIG. 1 shows a measurement signal 10 from a distance sensor of a laser cutting machine during the movement of a laser processing head of the machine to perform a separating cut in a panel-shaped workpiece as the head approaches an edge of the workpiece. The laser processing head moves in the x-direction over the workpiece.

In addition to the distance measurement signal, a measurement signal 11 from a photodiode for detecting scattered light during the processing of the workpiece is shown in the diagram.

Shortly before the laser processing head has reached an edge 12 of the workpiece, the distance signal 10 undergoes a rise 10.1. The scattered light signal 11 also undergoes a rise here 11.1, before falling (11.2) steeply when the edge 12 has been reached. The coincidence of the rise 10.1 of the distance signal 10 and the fall 11.2 of the scattered light signal 11 marks with high reliability the reaching of the edge 12 of the workpiece. The laser can be switched off here. The workpiece has been reliably severed. Damage to the base of the laser cutting machine caused by an excessively long active laser can be avoided.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for introducing a separating cut into a panel-shaped workpiece using a laser processing head of a laser cutting machine, the method comprising:
monitoring a distance of the laser processing head to the workpiece and detecting scattered light arising during a cutting process, at least when the separating cut approaches an edge of the workpiece; and
based on detecting an abrupt change in the distance between the laser head and the workpiece as well as a simultaneous abrupt change in an intensity of the detected scattered light, determining that the edge of the workpiece has been reached and switching off a laser of the laser processing machine.

2. The method according to claim 1, further comprising reducing an advancement speed of the laser processing head when the separating cut approaches the edge of the workpiece.

3. The method according to claim 2, further comprising reducing a laser power when the separating cut approaches the edge of the workpiece.

4. The method according to claim 3, wherein the laser power and the advancement speed are reduced simultaneously and linearly when the separating cut approaches the edge of the workpiece.

5. The method according to claim 1, further comprising capacitively measuring the distance between the laser processing head and the workpiece.

6. The method according to claim 1, wherein the scattered light is detected by a photodiode.

7. The method according to claim 1, further comprising, prior to processing of the workpiece, programming a length of the separating cut to be greater than a nominal dimension of the workpiece in a direction of the separating cut.

8. A laser cutting machine having a laser processing head configured to process panel-shaped workpieces, the laser cutting machine comprising:
a controller configured to carry out the method according to claim 1;
a sensor configured to measure the distance of the laser processing head to the workpiece; and
an optical sensor configured to detect the scattered light.

9. The laser cutting machine according to claim 8, wherein the sensor configured to measure the distance of the processing head to the workpiece is a capacitive sensor.

10. The laser cutting machine according to claim 8, wherein the optical sensor has at least one photodiode.

11. The method according to claim 1, further comprising reducing a laser power when the separating cut approaches the edge of the workpiece.
